(19) United States
(12) Patent Application Publication
(10) Pub. No.: US 2004/0214927 A1
(43) Pub. Date: Oct. 28, 2004

(54) Compatible multi-functional color concentrate compositions

(76) Inventor: Norman E. Nitzsche, Willard, OH (US)

Correspondence Address: POLYONE CORPORATION, 33587 WALKER ROAD, AVON LAKE, OH, 44012, US

(21) Appl. No.: 10/763,538

(22) Filed: Jan. 23, 2004

Related U.S. Application Data
(60) Provisional application No. 60/442,211, filed on Jan. 24, 2003.

(51) Int. Cl. C08K 5/34; C09K 11/02; C08K 3/18; C08K 3/04; C09D 4/00; C08K 5/00; C09C 1/36

(52) U.S. Cl. 524/88; 252/301.36; 106/499; 106/413; 106/447; 106/460; 106/476; 106/502; 524/430; 524/495

(57) ABSTRACT

Color concentrate compositions are disclosed, which contain colorant(s), binder, and polymer compatible with the base polymer to which the concentrate is intended to be added. The colorant is preferably one or more pigments. The compatible polymer preferably is the same polymer as the base polymer, although not necessarily the same molecular weight. The binder also serves as a surfactant to protect the compatible polymer. The presence of the compatible polymer in the concentrate enhances pellet integrity and adds the function of rheology modification to the base polymer when the concentrate is added.

### CLAIM OF PRIORITY

This application claims priority from U.S. Provisional Patent Application Serial No. 60/442,211 bearing Attorney Docket Number 12003004 and filed on Jan. 24, 2003.

### FIELD OF THE INVENTION

The present invention relates to a color concentrate composition, which is prepared for specific use with a base polymer.

### BACKGROUND OF THE INVENTION

Color is a major feature of consumer products and packaging for such products. Advertising and marketing relies on the ability of color to attract consumers to a particular product displayed on a commercial store shelf. Reliable production of consistent color thermoplastic polymers is a feature of the plastics industry.

The plastics industry uses concentrates or “master batches” of processing additives, colorants, modifiers, etc. for addition to and dispersion into base polymers, also conveniently known as “resins”, that are to be modified in some manner. Color concentrates generally comprise high concentrations of pigment dispersed in, and bound by, a binder. Color concentrates overcome the problem typically associated with free or natural state pigment such as dustiness and their tendency to become airborne and contaminate their surroundings.

Color concentrates predominantly contain colorants at a much higher concentration than is required in a final colored product. They are usually available in pellets, chips or non-dusting powders which are blended without solvent (“dry blended”) before processing with virgin or recycled base polymer in the correct proportions to achieve a preferred and reproducible color in the final product.

### SUMMARY OF THE INVENTION

The present invention relates to a multi-functional concentrate composition targeted for use with a base polymer, which can be utilized to both provide color to a thermoplastic polymeric material and improve the processability of the concentrate composition. Specifically, it has been found that processing of the concentrate composition in pellet form can cause breakage of the pellet prematurely, resulting in an undesirable amount of fines or dust, which the pellet is otherwise designed to minimize.

Unexpectedly, the problem is solved by a composition comprising an essential amount of at least one colorant, an essential amount of a compatible polymer, and a binder.

For purposes of this invention, “colorant” means a pigment, a dye, or both. One or more pigments, dyes, or combinations thereof, can be employed as colorant to make a particular color in the base polymer, according to techniques known to those skilled in the plastics industry.

For purposes of this invention, “compatible” means that the thermoplastic polymer of the concentrate composition and the base polymer are thermodynamic stable and do not delaminate during processing.

For purposes of this invention, “essential amount” means an amount that is enough for the ingredient to be effective in the purpose(s) for which the ingredient is included in the concentrate composition.

Optionally, the composition also comprises a blowing agent according to the needs of those skilled in the art, because the concentrate composition can gather a variety of polymeric modifiers to be added to the base polymer.

When the compositions of the present invention are blended at a desired ratio with a base polymer, numerous advantages are realized as the single composition performs multiple functions:

The pellet integrity is maintained at a greater than 90% level, reducing the amount of undesirable fines and dust.

The colorant adds color to the base polymer.

The compatible polymer beneficially affects the rheology of the base polymer. Specifically, it has been observed that the compatible polymer has a lower melt flow temperature than the wax binder which increases viscosity. The concentrate has an increased dispersion within the based polymer due to higher shear, resulting in better pigment dispersion throughout the melted base polymer. A more consistent coloration of the base polymer results.

Additional advantages will be discussed in relation to the embodiments of the invention.

### EMBODIMENTS OF THE INVENTION

Required Ingredients

The concentrate compositions of the present invention are useful to provide color or otherwise tint base polymers as well as improve the processability of such base polymers thereof.

In order to color or tint a base polymer, the compositions of the present invention contain colorants. Preferably, pigments are employed in the present invention.

Pigments can be inorganic and include metallic oxides, metal powder suspensions, earth colors, lead chromates, and carbon blacks; or organic including those derived from animal sources, vegetable sources, or synthetic processes. The pigment should be in particle form and should have a mean particle size between about 0.1 and about 100 μm and preferably between about 0.2 and about 50 μm. The most preferred mean particle size for organic pigments is about 0.2 μm. The most preferred particle size for inorganic pigments is about 50 μm. Generally the larger the particle size, the easier the pigment is to disperse.

Examples of organic and inorganic pigments which can be used in this invention include, but are not limited to, iron blue zinc oxide, titanium dioxide, chrome yellow, carbon black, chrome orange, chrome green, zinc chromate, red lead, lethol red, azo type toners, phthalocyanines, aluminum hydrates, lakes, iron oxide, white lead, extenders, phosphotungstic acid toners, titanium-containing pigments such as nickel titanate and antimony titanate, cobalt, sulfur-containing pigments, aluminum oxide, lithopane, ultrap hone, lead chromate, cadmium sulfide, cadmium selenide, barium sulfate, azo pigments, anthraquinone and vat pigments, phthalocyanine pigments, acrylamino yellow, magnesium oxide, chrome red, antimony oxide, zinc sulfide, magnesium fluoride and ground barytes. Benzoid pigments are useful and examples are toners and lakes. Examples of benzoid toners are yellow toners, e.g., benzoid yellows and Hansa yellows; organe toners, e.g., vat orange 3; red toners, e.g., napthol reds; violet toners; blue toners; green toners; brown toners; and black toners. Examples of benzoid lakes are yellow lakes, e.g., acid yellow 2; orange lakes; red lakes; violet lakes; blue lakes; e.g., acid blue 93; green lakes; brown lakes; and black lakes, e.g., natural black 3. Metallic pigments can be used, and examples are aluminum flakes. Mica-coated afflairs can also be utilized. Further colorants include pearlescent, phosphorescent, and fluorescent pigments. Typical organic and inorganic pigments are listed in Modern Plastics Encyclopedia, Mid-October 1989 Issue, Vol. 66, No. 11, McGraw-Hill, Inc., 1989, at pages 648-660, and the Kirk-Othmer Concise Encyclopedia of Chemical Technology, John Wiley & Sons, Inc. 1985, at pages 303-304 and 887-892, the contents of both of which are hereby incorporated by reference. Mixtures of pigments can be used.

Pigments are utilized in the color concentrate compositions of the present invention in a range generally from about 5 to about 85 weight percent of the concentrate composition, and preferably from about 50 to about 85 weight percent of the concentrate composition.

Another ingredient for the concentrate compositions of the present invention is a thermoplastic polymer “compatible” with the base polymer to which the concentrate composition is intended to be added.

Preferably, the compatible polymer can be identical in composition to the base polymer, although it is not a requirement that such polymers identical in composition be identical in molecular weight.

The compatible polymer can serve as a viscosity modifier, a melt flow modifier, or other modifier affecting the rheology of the base polymer. Moreover, the compatible polymer maintains better pellet integrity than a concentrate pellet without the compatible polymer. Preferably, the compatible polymer is styrenic when the base polymer to be colored is styrenic. Likewise, the compatible polymer is olefinic when the base polymer to be colored is olefinic. Also, polyester compatible polymer can be used with polyester base polymer for modification of rheological properties of the base polymer as a carbonated soft drink container, while the other required ingredient of the concentrate composition adds a reproducible color to the base polymer as it is molded into a carbonated soft drink container.

However, an example of non-identity of compatible and base polymer is the use of ethylene-vinyl acetate as a compatible polymer for polyolefinic base polymers such as polypropylene and polyethylene.

The compatible polymer differs from the conventional use of a polymer (identical or similar in composition to the base polymer) as a binder for a concentrate to be added to a base polymer, because the compatible polymer takes the form of particles that are themselves coated with the wax binder. Moreover, the formation of the concentrate pellet occurs at temperatures below the melting point of the compatible polymer, thereby assuring that the compatible polymer remains in particulate form. Thus, the wax binder serves as a surfactant for the compatible polymer. As such, the compatible polymer does not melt when being introduced into the concentrate composition of the present invention.

Thus, it is a feature of the present invention that pellets of the concentrate composition in effect have particles of pigment and particles of polymer intermixed in a binder of wax, which also serves as a surfactant.

The usefulness of the particles of compatible polymer is obtained both during that formation and storage of the concentrate pellets and also when when the concentrate composition is added to the base polymer intended to be colored.

The compatible polymer can comprise from about 1 to about 90 weight percent of the concentrate composition, and preferably from about 50 to about 75 weight percent.

Conversely, the combination of pigment, wax binder, and optional ingredients can comprise from about 5 to about 90 weight percent, and preferably from about 5 to about 25 weight percent.

A binder component is utilized in the compositions of the present invention. The binder can beneficially “wet” the pigments present and render them more dispersible in the base polymer to be colored. The binder components are waxes, which can be natural or synthetic. The waxes are generally solid at room temperature and have a weight average molecular weight of less than about 10,000. The binder component is present in the color concentrate compositions of the invention in amounts from about 1 to about 20 weight percent, and preferably from about 5 to about 15 weight percent.

Examples of waxes suitable for the binder component of the present invention include, but are not limited to, amide waxes such as ethylene bis-stearamide wax and hydroxystearamide wax, maleated ethylene waxes, maleated propylene waxes, microcrystalline waxes, oxidized waxes, paraffin waxes, petroleum waxes, polyethylene waxes, PTFE waxes, ethylene vinyl acetate waxes, wax esters, wax soaps, and polycaprolactone wax, or combinations thereof. The preferred binder component is a mixture of ethylene bis-stearamide wax and hydroxystearamide wax, at a ratio of about 60% to about 40%, respectively based on the total binder component. A further preferred binder component is a mixture of polycaprolactone wax and polyolefin wax, preferably in equal amounts, or a mixture of ethylene bis-stearamide wax, hydroxystearamide wax, polycaprolactone wax, and polyolefin wax. Of these preferred wax materials, one that is commercially available is Maxomer W-6000 from Chemax Polymer Additives.

Optional Ingredients

The multi-functional concentrate composition of the present invention can optionally include at least one functional compounding additive component including, but not limited to, nucleators, activators which lower the activation temperature of the blowing agent, surfactants, plasticizers, stabilizers, flame retardants, UV absorbers, fillers, fragrances, mold release aids, processing aids, biocides, and antistatic additives, anti-microbial agents and lubricants. The optional components including one or any combination of the above listed components are present in the color concentrate compositions in an amount generally from about 1 to about 85, and preferably from about 5 to about 25 weight percent.

Examples of commonly utilized functional compounding additives or components include alkylated phenols and bisphenols, alkylidene bis, tris, and polyphenols, thio and di-thiobis, tris and polyalkylated phenols, phenol condensation products, amines, esters, organic phosphites and phosphates, glycerol esters, glyceride, organic phosphate ester, mineral oil, quaternary ammonium compounds, anionics, alkane sulfonate, spheriglas, antimony mercaptide, berium cadmium liquids and powders, barium cadmium zinc liquids and powders, barium calcium zinc powders and liquids, barium organic, barium powder, barium zinc liquids and powders, cadmium liquids, cadmium zinc liquids, calcium powders, calcium tin zinc pastes, liquids, and powders, calcium zinc pastes, liquids, and powders, epoxies, hydroxyl amines, leads, mixed metal soaps, phenols, phosphites, single metal soaps, tins, zinc and zinc complex, catalysts, alcohol esters, complex esters, combination blends, costabilizing lubricants, fatty acids, fatty acid amides, fatty acid esters, fatty alcohols, glycol esters, metallic sterates, aluminum, barium, lithium, magnesium, sodium, stannous tin, polypropylene amorphous, and crystalline, silicones, abietic derivatives, acetic acid derivative, azelatic acid derivatives, benzoic acid derivatives, butene derivative, organic fillers, urea, zinc oxide, sodium benzoate, calcium carbonate, atomite, talc, boron nitride, zinc sterate, calcium sterate, sodium benzoate, urea, zinc oxide, barium sterate, glycols, alkanolamines, oxidizing agents/peroxides, lead sterate, magnesium oxide, stearic acid, salicyclic acid, nano-composites and diphenylguanidine (DPG).

Blowing agents are another optional ingredient for concentrate compositions of the present invention. Blowing agents can be endothermic, exothermic, or a combination thereof. The specific blowing agent utilized is selected to be active at or below the processing temperature or range of the base polymer being processed. Typical blowing agents, when activated, evolve or produce a gas such as nitrogen or carbon dioxide. As the gas evolves, the volume of the composition-base polymer mixture expands within the processing device. In order to prevent the blowing agent from prematurely activating or decomposing, the concentrate compositions are processed and preferably formed into particles below the activation temperature of the blowing agent. The particles are a conglomerate of the components of the present invention in a solid, non-liquid form such as but not limited to pellets, granules and flakes, with pellets being preferred.

During molding of a base polymer and a concentrate at elevated temperatures sufficient to degrade or activate the blowing agent, endothermic blowing agents will absorb heat as they degrade, which can reduce the cure time (mold closed) during a molding operation. The melt flow (polymer and concentrate) is placed under greater pressure by the blowing agent due to the evolution of gas. Accordingly, the injection pressures, as well as injection fill times can be reduced which results in both time and energy savings. The creation of a micro cell structure will eliminate such molding flaws as sinks. Cell structure is dictated by at least the volume of gas present in the melt flow (ml/gm) and the particle size of the nucleator. Eliminating or reducing the pack and hold portion of the injection cycle can also control over-packing. Also, a short shot of a reduced amount of base polymer and concentrate can be utilized to fill the cavity due to the cell expansion of the blowing agent. The compositions of the present invention will allow one to fill tool, which are oversized, for barrel capacity by increasing the overall volume.

Suitable commercially available blowing agents available from Mats Corp. Ltd. of Markham, Ontario as MS01, Cenblo Mat 100 or 500 (a carboxylic acid and carbonate based product), Uniroyal Chemical Company, Inc. of Middlebury, Conn., as Expandex® 5PT (a 5-phenyl tetrazole based product), EPI Environmental Plastics Inc. of Conroe, Tex., as EPIcor, Uniroyal Chemical Company of Middlebury, Conn., as Expandex and Reedy International Corp. of Keyport, N.J. as Safoam.

Non-limiting examples of endothermic blowing agents are polycarbonic acids, coating sodium bicarbonate, coated citric acid, coated mono sodium citrate, and coated sodium citrate. Exothermic blowing agents include azodicarbonamides, modified azodicarbonamides, oxybis benezene sulfony hydrazide (OBSH), toluenesulfonyhydrazides (TSH), 5-pheyltetrazole (5-PT), diisopropylhydrazodicarboxylate (DIHC), and dinitrosopentamethylenetetramine (DNPT).

Blowing agents in general are utilized in the color concentrate compositions of the present invention in amounts ranging from about 1.00 to about 85.00, and preferably from about 15.00 to about 75.00 weight percent. These amounts are sufficient to reduce the molding cycle time of a thermoplastic composition when compared to the same composition without the blowing agent.

Processing

Typical prior art color concentrate compositions are prepared or mixed at elevated temperatures in processing equipment such as extruders or two-roll mills. Conventional process equipment cannot be utilized to prepare the compositions of the present invention because there is insufficient binder to adequately wet out the pigment system, which creates processing difficulties and dispersion issues. High loadings of surfactants, in this case, W-6000, create over lubrication in the extrusion system, which results in screw slippage. Any product, which does pass through the extruder, is usually of very poor quality. Accordingly, the compositions of the present invention are processed at temperatures ranging from about 160° F. (71° C.) to 180° F. (82° C.), which are below the melting point of the compatible polymer.

While the preferred process for blending and preferably pelletizing the compositions of the present invention is described below, it is to be understood other processes known in the art and variations of the preferred process can also be utilized. The components of the composition including a pigment component containing desired pigment(s) and compatible polymer(s), and any optional ingredients such as blowing agent, minus any liquids and low temperature melting solids, are added to and mixed in a mixer, preferably a high intensity, bowl-type mixer known in the art and available from suppliers such as the Henschel Company of Germany. The mixer can be jacketed and connected to a temperature control system. The mixer has a rotary impeller that mixes as well as agitates the ingredients. The mixing action frictionally raises the temperature of the components. As the components are mixed, the pigment becomes ground, wetted, solvated and/or encapsulated by the other components, thereby providing excellent dispersion. When the temperature of the mixer reaches about 100° F. (38° C.), the low temperature melting solids, if any, are added to the composition and dispersed therein. The mixture is generally kept from exceeding 180° F. (82° C.).

After a suitable period of mixing time the composition can be further processed immediately, or allowed to set at or below ambient temperature for any length of time. At this time, the composition can generally be described as granular or sand-like. The granular composition is subsequently “cold” compression molded into particles preferably pellets. As used in the pelletizing industry, “cold” means that no external heat source such as gas or electricity is utilized in the compression molding process.

One such compression molding device is a die and roller type pellet mill which is well known in the art and available from manufacturers such as CPM of San Francisco, Calif. as Model CL series processors. Die and roller pelletizing utilizes compaction and extrusion to produce pellets ranging in length from about 0.0381 cm to about 2.54 cm, depending on the die utilized. The granular material from a supply hopper is fed continuously in a controlled stream to a pelletizing cavity. Rotation of a die in contact with the rollers causes the same to turn. The material carried by the rotation of the die is compressed between the die and the roll and forced through holes in the die. As pellets of the composition are extruded, a knife or other suitable cutting surface shears the pellets into lengths. Die sizes, and thus the pellets produced thereby may range from about 0.0381 cm to about 0.0635 cm in diameter with preferred sizes being about 0.158, 0.317, and 0.381 cm, respectively. Typically pellets are formed having an aspect ratio of 1 to 3.

The compositions of the present invention can be added to or melt blended with a targeted base polymer, either thermoplastic or thermoset, with which the compatible polymer is compatible. Examples of thermoplastic base polymer with which the compositions can be used include, but are not limited to, ABS resins prepared from acrylonitrile, butadiene and styrene; blends of ABS resins with other thermoplastics, such as, polyvinylchloride; diene resins; resins prepared from acrylonitrile, butadiene, styrene and alpha methyl styrene; resins prepared from butadiene, styrene and methacrylic acid; resins prepared from acrylonitrile, butadiene, styrene and methyl methacrylate acetal copolymers; acetal resins; acrylic resins and modified acrylic resins, such as, polymethyl methacrylate, copolymers of styrene and methyl methacrylate, copolymers of methyl methacrylate and alpha methyl styrene; the cellulosic plastics, such as, cellulose acetate plastics, cellulose acetate butyrate plastics, cellulose propionate plastics, ethyl cellulose plastics and cellulose nitrate plastics; mixtures of ethyl cellulose plastics and cellulose acetate butyrate; chlorinated polyether; the fluoroplastics such as, polytetrafluoroethylene, polyvinylidene fluoride, the fluorinate ethylene-propylene plastics and the chlorotrifluoroethylene plastics; the phenoxy resins; the polybutadiene-type resins, such as, butadiene-styrene copolymer and polybutadiene; the polycarbonates; polyolefins including polypropylene and polyethylene resins, such as, low-density polyethylene; copolymers of polyethylene with other materials; chlorinated polyethylenes; chlorosulfonated polyethylenes; ethylene vinyl acetate copolymer; ethylene acrylate copolymer; polyphenylene oxide; polypropylenes; the polysulfones; the polystyrenes; styrene copolymers, such as, styrene-methyl methacrylate copolymer; and vinyl polymers and copolymers, such as, polyvinyl chloride, copolymer of vinyl chloride and vinyl acetate, copolymer of vinyl chloride, vinyl acetate and vinyl alcohol, copolymer of vinyl chloride and vinylidene chloride, polyvinyldichloride, and combinations thereof.

Reinforced thermoplastic polymers can be used as base polymers. The reinforcing is normally done with glass fibers, metal fibers, refractory fibers, organic fibers such as from wood products and other fibers.

The color concentrate compositions of the present invention can be added to a base polymer prior to or during processing or molding in amounts that range generally from about 5 to about 50 weight percent of base polymer+concentrate composition, and preferably from about 10 to about 20 weight percent of the base polymer+concentrate composition.

### USEFULNESS OF THE INVENTION

The color concentrate compositions of the present invention offer numerous advantages. Manufacturing costs are reduced as the color concentrate compositions of the present invention include components heretofore contained in separate compositions. Time and labor expenditures are reduced as only the color concentrate compositions of the present invention need to be added to a base polymer or resin for molding instead of numerous compositions.

The ability of the color concentrate compositions to include high loadings of pigments allows for reduced “letdown” ratios. Overall, a great amount of versatility is offered by the color concentrate compositions of the present invention. The compositions of the present invention can be utilized at temperatures generally from about 121 ° C. to about 315° C.

The presence of the compatible polymer in the concentrate pellet enhances pellet integrity prior to use in the molding equipment.

Also, rheology is improved during the melt mixing of the concentrate pellets and the base polymer pellets, resulting in improved pigment distribution throughout the melted base polymer.

### EXAMPLE

The following examples illustrate the advantages of the color concentrate compositions of the present invention.

Table 1 shows the formulation of one embodiment (Example 1) of the present invention, compared with a formulation that does not contain compatible polymer.

TABLE 1

| | | Comparative | |
|---|---|---|---|
| | Commercial | Example A | Example 1 |
| Ingredient Name | Source | (Wt. %) | (Wt. %) |
| Macrolex Yellow | Bayer Corporation | 26.46 | 39.60 |
| 3G Pigment | | | |
| Blue K7090 | BASF Corporation | 13.23 | 19.84 |
| Heliogen Pigment | | | |
| Eastman 9921 | Eastman Chemical | 0.00 | 30.00 |
| Polymer Powder | Company | | |
| (PET) | (Voridian Div.) | | |
| Tech-Lube 500 | Technick Products, | 4.00 | 0.00 |
| Processing Aid | Inc. | | |
| Maxomer W-6000 | Chemax Polymer | 56.32 | 10.56 |
| Wax | Additives | | |

The concentrate compositions of Comparative Example A and Example 1 were prepared by weighing all of the components and loading them into a Henschel high-speed mixer. The ingredients were mixed on a low speed until the batch temperature was about 37° C. At this point, the mixer was set to a high speed and mixing continued until the batch was dense, approximately 60° C. for Comparative Example A and approximately 74° C. for Example 1. The resulting batches had a consistency of wet sand. The two batch were formed into pellets using a Model CL Pelletizer from CPM, as described above. Pellets having a diameter of 0.159 cm and an aspect ratio of 1-2 were prepared.

To determine pellet integrity, the following test was conducted:

1. The sample weight for testing was 100 grams.

2. Each sample was weighed in the appropriate test vessel and placed on a Red Devil brand, duel-head, paint shaker.

3. The process time was one minute. The shaker operated at only one speed.

4. Once the shaker has stopped, the material is then processed through an 18-mesh screen.

5. A successful test was achieved if a 90% minimum of the original weight (i.e., 90 grams) remained on the 18-mesh screen.

The result for Comparative Example A was <80%.

The result for Example 1 was >94%.

Thus, pellet integrity is unexpectedly enhanced by the presence of compatible polymer in the concentrate compositions of the present invention.

The invention is not limited to the above embodiments. The claims follow.

1. A color concentrate composition for polymeric materials comprising:
an essential amount of at least one colorant,
an essential amount of a compatible polymer,
a wax binder, and
a functional compounding additive component selected from the group consisting of blowing agent, nucleators, activators which lower the activation temperature of the blowing agent, surfactants, plasticizers, flame retardants, fillers, fragrances, mold release aids, processing aids, biocides, and antistatic additives, anti-microbial agents, lubricants, and combinations thereof.

2. The composition of claim 1, wherein the colorant is a dye, a pigment, or both.

3. The composition of claim 1, wherein the composition further comprises a stabilizer or a UV absorber.

4. The composition of claim 2, wherein the pigment is selected from the group consisting of inorganic pigments and organic pigments and has a mean particle size of between about 0.1 and about 100 μm.

5. The composition of claim 4, wherein the inorganic pigments and organic pigments are selected from the group consisting of iron blue zinc oxide, titanium dioxide, chrome yellow, carbon black, chrome orange, chrome green, zinc chromate, red lead, lethol red, azo type toners, phthalocyanines, aluminum hydrates, lakes, iron oxide, white lead, extenders, phosphotungstic acid toners, nickel titanate, antimony titanate, cobalt, sulfur-containing pigments, aluminum oxide, lithopane, ultraphone, lead chromate, cadmium sulfide, cadmium selenide, barium sulfate, azo pigments, anthraquinone, phthalocyanine pigments, acrylamino yellow, magnesium oxide, chrome red, antimony oxide, zinc sulfide, magnesium fluoride and ground barytes.

6. The composition of claim 4, wherein the pigments are selected from the group consisting of pearlescent, phosphorescent, and fluorescent pigments.

7. The composition of claim 1, wherein the pigments comprise from about 5 to about 85 weight percent of the composition.

8. The composition of claim 1, wherein the compatible polymer comprises from about 1 to about 90 weight percent of the composition.

9. The composition of claim 1, wherein the binder is a wax selected from the group consisting of amide waxes, maleated ethylene waxes, maleated propylene waxes, microcrystalline waxes, oxidized waxes, paraffin waxes, petroleum waxes, polyethylene waxes, PTFE waxes, ethylene vinyl acetate waxes, wax esters, wax soaps, and polycaprolactone wax, and combinations thereof.

10. (Canceled)

11. A method of making a color concentrate composition, comprising the steps of:
(a) mixing pigment and compatible polymer in a mixer;
(b) adding binder when the temperature of the mixer reaches about 38° C.;
(c) continue mixing pigment, compatible polymer, and binder at a temperature below about 82° C. to form a mixture; and
(d) cold compressing the mixture in a mill without an external heat source to form particles.

12. The method of claim 11, wherein the particles form by step (d) are pellets having a length ranging from about 0.0381 cm to about 2.54 cm and a diameter from about 0.0381 cm to about 0.0635 cm.

13. The method of claim 11, wherein the particles are pellets having an aspect ratio of 1 to 3.

14. The method of claim 11, wherein step (a) further includes mixing a blowing agent.

15. A method of using the composition of claim 1, comprising the steps of:
(a) mixing the composition of claim 1 with a base polymer with which the compatible polymer of the composition of claim 1 is compatible; and
(b) melt blending the composition of claim 1 with the base polymer to form a color compound.

16. The method of claim 15, wherein the base polymer is selected from the group consisting of ABS resins prepared from acrylonitrile, butadiene and styrene; blends of ABS resins with thermoplastics; diene resins; resins prepared from acrylonitrile, butadiene, styrene and alpha methyl styrene; resins prepared from butadiene, styrene and methacrylic acid; resins prepared from acrylonitrile, butadiene, styrene and methyl methacrylate acetal copolymers; acetal resins; acrylic resins and modified acrylic resins; cellulosic plastics; mixtures of ethyl cellulose plastics and cellulose acetate butyrate; chlorinated polyether; fluoroplastics; phenoxy resins; polybutadiene resins; polycarbonates; polyolefins; copolymers of polyethylene with other materials; chlorinated polyethylenes; chlorosulfonated polyethylenes; ethylene vinyl acetate copolymer; ethylene acrylate copolymer; polyphenylene oxide; polysulfones; polystyrenes; styrene copolymers; vinyl chloride based polymers and copolymers; and combinations thereof.

17. The method of claim 15, wherein the composition of claim 1 comprises from about 5 to about 50 weight percent of the color compound.

18. The method of claim 15, wherein the composition of claim 1 further comprises a blowing agent.

19. The method of claim 15, wherein the composition of claim 1 further comprises a functional compounding additive component selected from the group consisting of nucleators, activators which lower the activation temperature of the blowing agent, surfactants, plasticizers, stabilizers, flame retardants, UV absorbers, fillers, fragrances, mold release aids, processing aids, biocides, and antistatic additives, anti-microbial agents and lubricants.

20. The method of claim 15, wherein the compatible polymer of the composition of claim 1 and the base polymer are thermodynamic stable and do not delaminate during processing.
